(19) United States
(12) Patent Application Publication
(10) Pub. No.: US 2008/0130297 A1
(43) Pub. Date: Jun. 5, 2008

(54) Modular lamp shade

(75) Inventor: Gary Hui, Kowloon (CN)

Correspondence Address: DENNIS B. HAASE, P.O. BOX 6206, HOT SPRINGS, AR, 71902-6206, US

(73) Assignee: Mastercraft International USA, Inc.

(21) Appl. No.: 11/636,088

(22) Filed: Dec. 4, 2006

(51) Int. Cl. F21V 1/06

(52) U.S. Cl. 362/352; 362/356

(57) ABSTRACT

A modular lamp shade assembly in which upper and lower rings are clipped to a shade. The shade is multi layered in which one of the layers is of a material that is relatively flexible along its horizontal axis and relatively rigid in its vertical axis such that the shade in its assembled state is free of wrinkles and other deformities.

The present invention relates, in its most rudimentary form, to lamp shades and, more particularly, to modular lamp shades constructed from a series of parts which are of such size and material as to be easily packed and readily assembled for use.

### BACKGROUND OF THE INVENTION

1. Field of the Invention

For several years, and particularly since manufacturing on the Pacific Rim has become a vital adjunct to the economy, efforts to devise products which can be packaged, shipped and stored with relative ease and at minimal cost are ongoing.

Lamp shades are very economically made in Pacific Rim countries, but some of that economic benefit is lost because of their bulk relative to their weight. While the basic structure of a lamp shade has not materially changed, there are myriad efforts to fashion the basic elements in a manner which permits them to be formed as separable units and later assembled, thereby minimizing the bulk for shipping. The present invention represents a marked advance in that effort.

2. Description of the Related Art

Several efforts in the patent art have been directed to various aspects of lamp shade construction, and in later years, the ability to pack and ship an otherwise bulky lamp shade with minimal cost, among them:

Weisbrod U.S. Pat. No. 4,055,760 has an adhesive member 24 which extends vertically between the rings. Chambard U.S. Pat. No. 4,212,052 is another example wherein velcro not only holds the shade together, but also clamps in the upper and lower ring.

Tang, U.S. Pat. No. 4,772,992, illustrates another form of snap-in device and appears to have a wire stiffener running vertically.

Gall, U.S. Pat. No. 4,383,291, and Glendmyer, U.S. Pat. No. 5,662,412, both appear to use special devices to hold the rings in place.

Fauri, U.S. Pat. No. 3,780,287, which is a Spanish inventor, has a very broad claim in his patent. Okamoto, U.S. Pat. No. 3,142,446, is simply more of the same. Borowitz, U.S. Pat. No. 4,275,434, Naumoff, U.S. Pat. No. 4,727,461, Mo, U.S. Pat. No. 4,745,532 and Juang, U.S. Pat. No. 6,561,682, all have a framework which consists of holding the upper and lower rings apart.

The patent to Yang, U.S. Pat. No. 6,773,145, has connecting elements 24 which assist in some respects and Lin, et al., U.S. Pat. No. 6,837,597, has clips which appear to provide some vertical support for the shade.

### SUMMARY OF THE INVENTION

In an industry that is constantly seeking improvement, because improvement means savings, the substantial number of efforts represented by the patent art stands as mute evidence that the ultimate has not yet been achieved.

It is an objective of the present invention to provide the industry with a modular lamp shade which may be packed in its disassembled state in a very small space without fear of damage.

It is another objective of the present invention to provide a lamp shade that meets the foregoing criteria and may be assembled and disassembled in a very short time. It is a further objective, related to the foregoing, to provide such a lamp shade which, when assembled, has the appearance of a shade which was made and assembled at the factory.

Yet another objective is to eliminate vertical struts and other mechanical structures, common in other shades, to hold the shade in a taut posture, eliminating sagging, wrinkles and like unsightly deformities.

Another, and still further, objective of the present invention is to create a modular lamp shade which may be configured in a variety of shapes and sizes without giving up any of the benefits of the present invention.

Additional objectives and advantages of the present invention will occur to those skilled in the art from a study of the following Detailed Description of the Present Invention, when taken with the drawings, wherein:

### DESCRIPTION OF THE DRAWINGS

FIG. 1 is an exemplary lamp upon which is mounted a lamp shade assembly constructed in accordance with the present invention;

FIG. 2 is a top plan view of the exemplary shade assembly of FIG. 1;

FIG. 3 is a view of the modular lamp shade assembly of FIG. 1 with the various elements of the shade assembly shown in their disassembled state;

FIG. 4 is an exploded view of the lamp shade assembly of FIG. 1 with the top ring element positioned above the lamp shade assembly and indicating its path as it becomes affixed in the shade assembly;

FIG. 5 is a view similar to FIG. 4, but illustrating the lower ring element of the shade assembly in position to be affixed in the assembly;

FIG. 6 is a partial sectional view taken along lines 6-6 of FIG. 2 and illustrating the details of the construction of the lamp shade and the clips which hold the rings in place; and,

FIG. 7 is a perspective view of an exemplary clip with one of the rings about to be affixed in the clip.

### DETAILED DESCRIPTION OF A PREFERRED EMBODIMENT

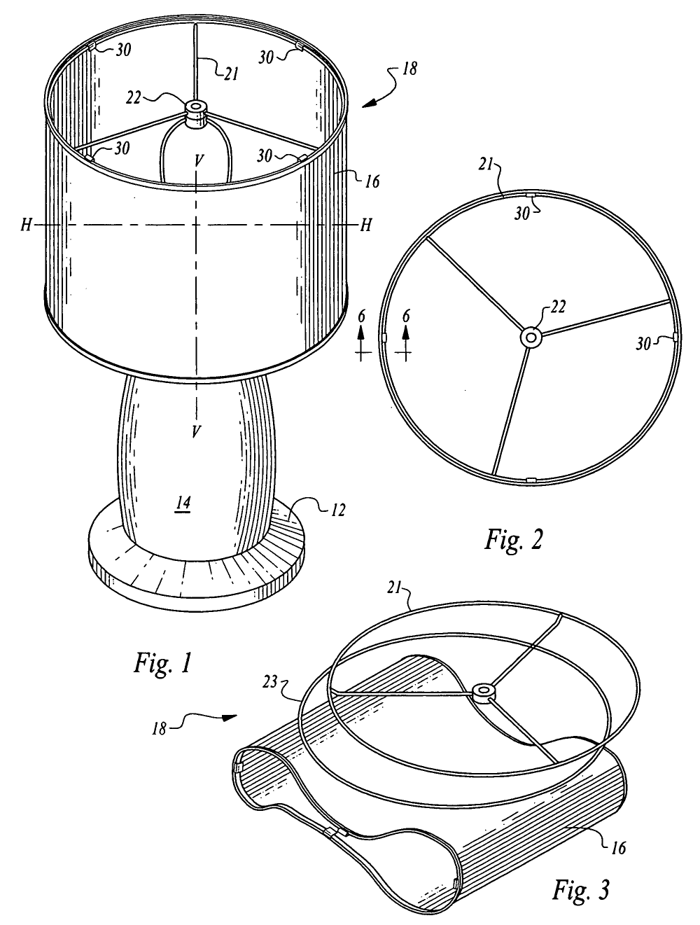

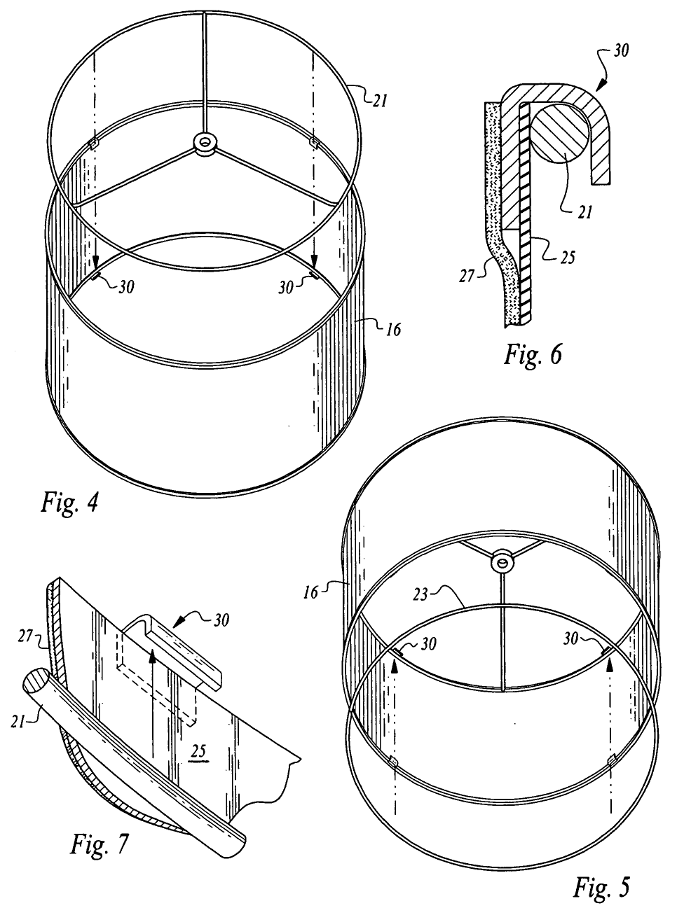

Referring now to the drawings, and initially to FIG. 1, an exemplary lamp 10 is illustrated. The lamp 10 has a base 12 which supports the lamp and body 14, which may be of any shape. A lamp shade 16 is supported on the base where it circumscribes an illuminating device, e.g., an incandescent or flourescent device, not shown.

The shade 16 is a model of simplicity, yet capable of achieving all of the objectives attributable to it. Referring to FIGS. 2 and 3, the shade 16 is shown disassembled, providing an insight into its elemental structure.

Giving due consideration to the shape of the shade, which in this example is round, an upper ring 21 and a lower ring 23 are shown. Both rings are circular in that the shade is circular. The upper ring is formed with a spider terminating in a final which attaches to the lamp's harp [not shown] in the usual manner. It is evident that where the shade is of another shape, the rings will assume a complimentary shape.

The shade 16 itself is a key to the success of the shade assembly 18 in that it permits collapse for shipping and storage and may be erected to define a stable and pleasant appearing shade.

To this end, the shade 16 is of a multi ply construction. An inner liner 25 is provided over which a cover 27 is fitted. The inner liner 25 comprises a preferably seamless loop of plastic material which is, in keeping with the invention, relatively flexible in its horizontal axis H-H, while being relatively rigid in its vertical axis V-V. The liner is preferably of a translucent material that is capable of softening and dispersing light rays from the illuminating element, whatever it might be.

The cover 27 may be of any number of decorative fabrics or like materials and is fitted about the liner 25 in any one of several known methods, e.g., glueing.

The upper and lower rings 21 and 23, respectively, are preferably of a light weight and relatively malleable material formed into a geometric shape and so constructed as to define the shape of the shade 16. To accomplish this end, clips 30 are provided in spaced relation about the top and bottom edges of the shade 16. The clips 30 may be conveniently fixed between the inner liner 25 and the cover 27, in any number of known methods. As best seen in FIG. 7, the upper and lower rings snap into the clips 30, thereby forming the shade to conform to the circumference of the rings 21, 23.

In keeping with the objectives of the invention, the relative stiffness of the inner liner in its vertical axis, when the lamp assembly is in its assembled mode, keeps the shade 16 free of wrinkles, waves and other deformations, giving the shade the appearance of having been assembled at the factory, without struts or other structural devices, and without relying on gravity.

With reference now to FIG. 3, an important feature of the present invention is graphically illustrated. Each element of the modular lamp shade assembly 18 is shown in its disassembled form with the upper and lower rings 21 and 23, respectively, resting on top of the collapsed shade 16. It will be seen in FIG. 3 that the shade 16, in its disassembled form, will lie essentially flat with some curvature at both ends. Thus, the entire assembly 18 can be packed and stored in a very limited space, making it economically practical to ship and store in a disassembled state.

It will become clear to those skilled in the art from a reading of the description of this preferred embodiment, that some variation in the specific elements of the modular lamp shade is possible and within the contemplation of the invention as set forth in the following claims, wherein:

1. A modular lamp shade assembly for use in conjunction with an illuminating device such as a lamp, said lamp shade assembly comprising;
a shade, said shade including an inner liner and a cover; said inner liner being relatively rigid along its vertical axis, while being relatively flexible along its horizontal axis;
an upper ring, said upper ring having a spider terminating in a final; a lower ring;
a series of clips on said shade, said rings being adapted to snap into said clips and held thereby when said lamp shade assembly is assembled.

2. The modular lamp shade assembly of claim 1, wherein said inner liner is translucent.

3. The modular lamp assembly of claim 1, wherein said upper and lower rings are geometric in shape.

4. The modular lamp assembly of claim 2, wherein said upper and lower rings are geometric in shape.

5. The modular lamp assembly of claim 1, wherein said rings are malleable.

6. The modular lamp assembly of claim 3, wherein said rings are malleable.

7. The modular lamp assembly of claim 5, wherein said inner liner is translucent.
